(19) United States
(12) Patent Application Publication
(10) Pub. No.: US 2025/0226194 A1
(43) Pub. Date: Jul. 10, 2025

(54) APODIZATION SPECIFIC FITTING FOR IMPROVED RESOLUTION, CHARGE MEASUREMENT AND DATA ANALYSIS SPEED IN CHARGE DETECTION MASS SPECTROMETRY

(71) Applicant: THE REGENTS OF THE UNIVERSITY OF CALIFORNIA, Oakland, CA (US)

(72) Inventors: Evan R. Williams, Oakland, CA (US); Conner C. Harper, Albany, CA (US); Zachary M. Miller, Berkeley, CA (US)

(73) Assignee: THE REGENTS OF THE UNIVERSITY OF CALIFORNIA, Oakland, CA (US)

(21) Appl. No.: 19/033,376

(22) Filed: Jan. 21, 2025

Related U.S. Application Data
(63) Continuation of application No. PCT/US2023/030207, filed on Aug. 15, 2023.
(60) Provisional application No. 63/398,210, filed on Aug. 15, 2022.

(51) Int. Cl. H01J 49/00

(52) U.S. Cl. CPC H01J 49/0036

(57) ABSTRACT

A method for Charge Detection Mass Spectrometry (CDMS) with improved accuracy with reduced computation requirements. An apodization-specific peak fitting function is used to determine peak amplitudes and frequencies in the Fourier transform of ion signals to measure the charge and mass of an individual ion in charge detection mass spectrometry. Up to approximately 28% or more amplitude measurement precision is achieved when compared to conventional peak picking methods. About a 9-fold less computational effort is required to achieve the same accuracy of determining peak amplitude and frequency as the standard method of zero fill-based interpolation.

### CROSS-REFERENCE TO RELATED APPLICATIONS

This application claims priority to, and is a 35 U.S.C. § 111(a) continuation of, PCT international application number PCT/US2023/030207 filed on Aug. 15, 2023, incorporated herein by reference in its entirety, which claims priority to, and the benefit of, U.S. provisional patent application Ser. No. 63/398,210 filed on Aug. 15, 2022, incorporated herein by reference in its entirety. Priority is claimed to each of the foregoing applications.

The above-referenced PCT international application was published as PCT International Publication No. WO 2024/039633 A1 on Feb. 22, 2024, which publication is incorporated herein by reference in its entirety.

### STATEMENT REGARDING FEDERALLY SPONSORED RESEARCH OR DEVELOPMENT

This invention was made with Government support under Grant Numbers GM066698 and GM139338 awarded by the National Institutes of Health and under Grant Number DE-AC02-05CH11231 awarded by the U.S. Department of Energy. The Government has certain rights in the invention.

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to mass spectrometry systems and methods, and more particularly to charge detection mass spectrometry (CDMS) methods with improved accuracy, increased computation efficiency and resolution.

### 2. Background

Native mass spectrometry (MS) is widely used to obtain information about the structures, stoichiometries and interactions of molecules and molecular complexes directly from aqueous solutions. In conventional MS, ensembles of ions are measured to yield m/z spectra, where analyte charge and subsequently, mass, is determined either from the charge-state distributions of individual constituents or from the spacing of isotopic peaks in a single charge state. Analyte mass can become difficult to deduce with increasing molecular size and with increasing sample heterogeneity due to the inability of the apparatus to resolve individual charge states. Mass information has been obtained from highly purified virus capsids with masses ˜18 MDa, but often no information can be obtained even for much smaller molecular complexes that are more heterogeneous.

One solution to the problem of sample heterogeneity is to weigh ions individually so that there are no interferences with other components in the sample. Single ion mass measurements have been demonstrated with a number of different types of mass spectrometers, including Fourier-transform ion cyclotron resonance, quadrupole ion trap, Orbitrap, and charge detection mass spectrometers that employ simple electrostatic traps. In each of these methods, the frequency of ion motion is related to ion m/z. The charge can be determined either by stripping or adding a single charge. Alternatively, charge can be determined directly from the amplitude of the signal on charge sensitive detectors. Single ion detection has also been demonstrated with time-of-flight mass spectrometry with energy-sensitive superconducting tunnel junction cryodetectors and with nanomechanical resonators.

In charge detection mass spectrometry (CDMS) with electrostatic ion traps, the signal amplitude and hence the charge of an ion can be determined more accurately by increasing measurement time to improve signal-to-noise (S/N) ratios. This improved accuracy comes at the cost of analysis time. To date, the lowest charge uncertainty that has been reported is 0.174 e and that was achieved with a transient length of 3 seconds using a cryogenically cooled charge sensitive preamplifier to reduce noise.

Because ion frequencies can evolve with time, short time Fourier-transforms (STFT) are used to analyze these data using step sizes that are sufficiently small so that changes in ion frequency are negligible. The FT of an individual time-domain segment results in bins in the frequency domain data that have widths that are inversely related to the length of the transformed data. Shorter time-domain sections can lead to a loss of frequency resolution in the frequency domain and errors in peak amplitude known as scalloping loss. Scalloping loss occurs when there are an insufficient number of points to be able to adequately identify a peak maximum using pick picking routines that represent the centroid of a peak by the highest value point. This approach leads to an error in peak frequency and a systematic underestimation of peak amplitude. This is especially problematic for CDMS measurements where peak amplitudes are used to determine ion charge and may also be used to determine ion energy.

Scalloping loss can be reduced by zero-filling, where time domain data is extended by adding values of zero. This increases the number of points in the frequency domain but does not affect peak resolution. Although scalloping loss can be essentially eliminated with a sufficient number of zero-fills, the longer time-domain data sets can increase the computational time significantly. Because of the lengthy computation time required in CDMS, data is either processed off-line or processed in real time with a 48-core parallelized server. Therefore, there is a need for new computational methods that will address these challenges.

### BRIEF SUMMARY

Short-time Fourier transforms with short segment lengths are typically used to analyze single ion charge detection mass spectrometry (CDMS) data either to overcome effects of frequency shifts that may occur during the trapping period or to more precisely determine the time at which an ion changes mass, charge or enters an unstable orbit. The short segment lengths can lead to scalloping loss unless a large number of zero-fills are used, making computational time a significant factor in real time analysis of data.

To address the foregoing deficiencies in prior approaches, this disclosure describes apodization specific fitting that can lead to a 9-fold reduction in computation time compared to zero-filling to a similar extent of accuracy. This makes possible real-time data analysis using a standard desktop computer. Rectangular apodization leads to higher resolution than the more commonly used Gaussian or Hann apodization and makes it possible to separate ions with similar frequencies, a significant advantage for experiments in which the masses of many individual ions are measured simultaneously. Equally important is a >20% increase in S/N obtained with rectangular apodization compared to Gaussian or Hann, which directly translates to a corresponding improvement in accuracy of both charge measurements and ion energy measurements that rely on the amplitudes of the fundamental and harmonic frequencies. Combined with computing the fast Fourier transform in a lower-level language, this fitting procedure eliminates computational barriers by enabling real time processing of CDMS data on a laptop computer.

According to one aspect of the technology, a peak fitting method is provided that uses an apodization-specific peak fitting function to determine peak amplitudes and frequencies in the Fourier transform of ion signals to measure the charge of an individual ion in charge detection mass spectrometry.

Another aspect of the technology is to provide a method that has about a 9-fold less computational effort required to achieve the same accuracy of determining peak amplitude and frequency as the standard method of zero fill-based interpolation.

A further aspect is a method wherein rectangular apodization is employed in the peak fitting function; a non-linear least squares fitting is applied to Fourier transformed ion signals; a known peak shape is used for fitting frequency domain data and a greater than approximately 20% increase in signal to noise ratio can be achieved.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 is a functional block diagram of a method for charge detection mass spectrometry that uses an apodization-specific peak fitting function to determine peak amplitudes and frequencies in the Fourier transform of ion signals according to one embodiment of the technology.

FIG. 2 is a plot of a comparison of peak picking and sinc fitting for a single AAV ion using 50 ms of time-domain data and two zero-fills (150 ms of time-domain data) compared to 39 zero-fills (2000 ms of time domain data) with time-domain data starting at 500 ms showing significant scalloping loss with peak picking (triangle points) compared to sinc fitting function and overlapping zero-filled to 2000 ms.

FIG. 3 is a plot of a comparison of peak picking and sinc fitting for a single AAV ion using 50 ms of time-domain data and two zero-fills (150 ms of time-domain data) compared to 39 zero-fills (2000 ms of time domain data) with time-domain data starting at 570 ms showing that scalloping loss is minimal.

FIG. 4 is a plot showing deviations in peak amplitude from peak picking and sinc fitting compared to data that was zero-filled to 2000 ms (dashed line) over the course of the 1 second trapping period;

FIG. 5 is a plot of average peak amplitude and standard deviation of a single AAV9 ion obtained using peak picking and 39 zero-fills (first), sinc fitting and two zero-fills (center), and peak picking and two zero-fills (third).

FIG. 6 is a plot depicting charge histograms showing normalized counts as a function of peak amplitude (charge) for ˜400 cpTMV-S65-3NY ions using sinc fitting (top) and peak picking (bottom) showing improved charge state resolution with sinc fitting. Data bin widths are 0.05 e and are smoothed using a Savitzky-Golay filter.

FIG. 7 shown STFT data between 725 and 975 ms showing frequency vs. time for three AAV9 ions that have similar oscillation frequencies,

FIG. 8 is a plot of FT data in a window centered at 885 ms (a single “slice” of the STFT) obtained using a rectangular, Hann and Gaussian apodization functions illustrating that two ions that are not resolved by the latter two functions are clearly resolved with rectangular apodization function.

FIG. 9 is a plot of S/N of a single AAV9 ion over each “slice” of the STFT for the 1 second trapping period for the three apodization functions of FIG. 7.

FIG. 10 is a graph of computation time (left y-axis) required to obtain the frequencies and signal amplitudes (charge) of 20-one second trapping events for 56 total ions as a function of number of added zero-fills (x-axis) for peak picking (open circles) and sinc fitting (open triangle). The percent difference in peak amplitudes (right y-axis) for peak picking (filled circles) and sinc fitting (filled triangle) compared to amplitudes obtained using 39 zero-fills (2000 ms time-domain data length).

FIG. 11 shows plots of baseline frequency domain noise levels for the rectangular (top), Hann (middle) and Gaussian (bottom) apodization functions in the frequency range of 22 kHz-27 KHz. Dashed black lines indicate the average value of the noise within the plotted frequency range, and are 2.67 a.u., 3.60 a.u., and 3.98 a.u. for the rectangular, Hann and Gaussian windows, respectively.

FIG. 12 is an LC-MS characterization of purified cpTMV-S65-3NY monomer (expected MW: 17813 Da).

### DETAILED DESCRIPTION

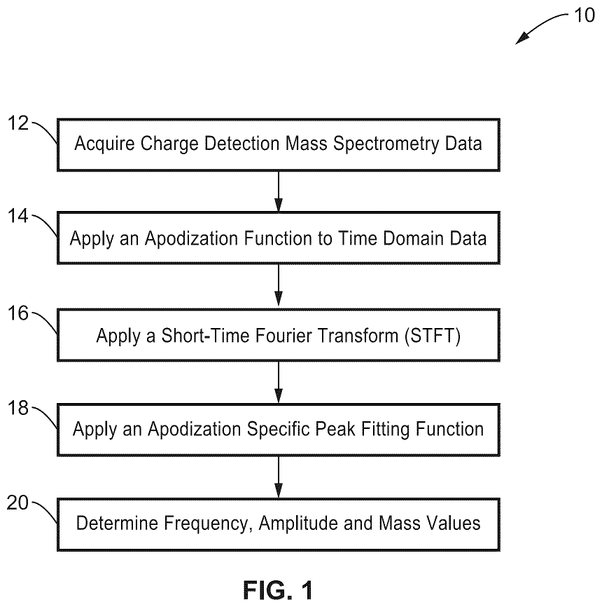

Referring more specifically to the drawings, for illustrative purposes, mass spectrometry systems and methods of charge detection and data analysis are generally shown. Several embodiments of the technology are described generally in FIG. 1 to FIG. 12 to illustrate the characteristics and functionality of the systems and methods. It will be appreciated that the methods may vary as to the specific steps and sequence and the systems and apparatus may vary as to structural details without departing from the basic concepts as disclosed herein. The method steps are merely exemplary of the order that these steps may occur. The steps may occur in any order that is desired, such that it still performs the goals of the claimed technology.

Turning now to FIG. 1, a method 10 for charge detection mass spectrometry signal processing with increased resolution, improved charge measurements and increased data analysis speed is shown schematically. At block 12 of the processing method, charge detection mass spectrometry data is acquired from a spectrometer. Generally, charge detection mass spectrometry allows the determination of the masses of individual ions from the simultaneous measurements the mass/charge (m/z) ratio and the charge of each ion. Ions are typically passed through a conducting cylinder and caused to oscillate back and forth producing a time domain signal that is normally analyzed by a fast Fourier transformation and the oscillation frequency and ion energy are used to produce the m/z ratio.

In single ion charge detection mass spectrometry measurements, where the m/z of an ion is obtained from the oscillation frequency and ion energy, and the charge of the ion is determined from the amplitude of the induced signal, accurate amplitude measurements are significant. Scalloping loss arising from peak picking of limited time-domain data segments in short time Fourier-transform (STFT) analysis of CDMS data can occur unless a large number of zero-fills are used for each segment. However, this comes at a significant cost of computation time leading to the use of off-line data analysis on standard desktop computers or a highly efficient computing cluster for real time data analysis.

Accordingly, an apodization function is applied to the acquired raw CDMS data at block 14. This initial apodization is preferably a rectangular function, but other suitable apodization functions may also be used to process the acquired raw CDMS data in block 14.

Accordingly, a Fourier transform is applied to the apodized CDMS data at block 16. This initial transform is preferably a short time Fourier transform but other suitable transforms may also be used to process the apodized CDMS data at block 16.

At block 18 an apodization specific peak fitting is applied to reduce scalloping losses, decrease computation times and improve analysis accuracy. An apodization specific peak fitting application at block 18 greatly reduces the number of zero-fills necessary to eliminate scalloping losses, making the data analysis significantly more efficient. This also results in improved accuracy in both frequency and amplitude determination and can be done in real time using a modest desktop computer. The application of this method improves amplitude-based charge state determination and individual ion energy measurements.

Specifically, frequency domain data is fitted with a known peak shape in order to better obtain a precise amplitude and frequency measurement at block 18. In one embodiment, for example, the time-domain data is apodized using either a rectangular, Hann or Gaussian apodization function, zero-filled, and subsequently analyzed using a STFT, where transients are divided into segments of time at block 16. The frequency domain peaks are then fit according to an apodization specific peak fitting function in block 18.

Because apodized time-domain data produces peak shapes in the frequency domain that are characteristic of the apodization function used, non-linear least squares fitting of Fourier transformed ion signals can be implemented in order to significantly improve charge measurement without significantly increasing computation time. Non-linear least squares fitting provides a continuous interpolation of peaks computed with the FFT and thereby circumvents charge uncertainty stemming from scalloping loss. Fitting also greatly reduces computation time costs relative to zero-filling because the fitting algorithm only requires four points in the vicinity of an ion signal.

Zero-filling the original data with two times the length of real data being transformed is sufficient for this fitting technique to obtain highly accurate amplitudes, as opposed to zero-filling upwards of 20 to 40 times the length of real data to obtain similar accuracies without fitting. This represents over a factor of ten improvement in computational speed, a limiting factor in making CDMS a practical method for mass measurements.

At block 20 the final frequency, amplitude and mass values are computed from the processed data. In sum, the apodization specific peak fitting methods will significantly reduce the number of zero-fills necessary to eliminate scalloping losses, making the data analysis significantly more efficient. This also results in improved accuracy in both frequency and amplitude determination and these computations can be done in real time using a modest desktop computer. The application of this method will improve amplitude-based charge state determination and individual ion energy measurements.

The technology described herein may be better understood with reference to the accompanying examples, which are intended for purposes of illustration only and should not be construed as in any sense limiting the scope of the technology described herein as defined in the claims appended hereto.

### Example 1

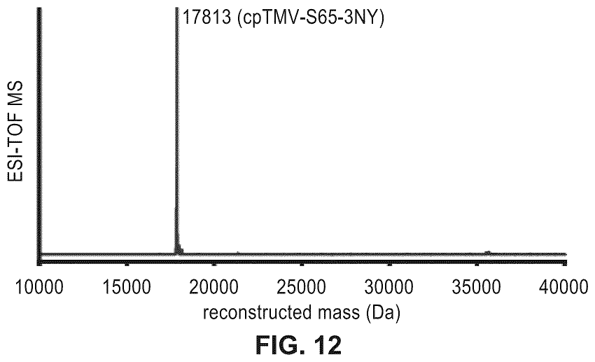

In order to demonstrate the data processing methods and functionality of the systems, a sample of adeno-associated viruses (AAVs) was prepared providing AAV9 ions for analysis. (See e.g. FIG. 12). Experiments were performed using an in-house built charge detection mass spectrometer. Ions were generated using electrospray ionization with borosilicate glass capillaries that are held at a potential of 1-3 KV relative to the entrance cone of the mass spectrometer (250 V) at a distance of approximately 3 mm. Ions passed through a modified Z-spray source (Waters Corporation, Milford, MA, USA), a quadrupole ion guide and were trapped and thermalized for up to 1 second in a linear quadrupole (Ardara Technologies, Ardara, PA, USA) at a potential ˜200 V. Ions were pulsed out of the trapping quadrupole and passed through a 90 degree turning quadrupole, which admits ions with a limited spread of kinetic energies into an electrostatic ion trap. The front of the trap was held at 0 V to allow ions to enter the trap and the potential is quickly raised to 330 V to trap and store ions. Measurements were made for trap times of either 1 second or 7.5 seconds. The charge-induced signals of trapped ions were amplified by a room temperature CoolFET charge-sensitive preamplifier (Amptek, Bedford, MA, USA) and a linear voltage amplifier. The output of the preamplifier was passed through a custom-built Butterworth bandpass filter with low and high cutoff frequencies of 10 kHz, and 300 kHz, respectively. The signal was digitized at 1 MHz using an ATS9350 digitizer board (AlazarTech, Pointe Claire, Quebec, CA).

Adeno-associated viruses (AAVs) are used as gene delivery agents to treat rare genetic disorders and assemblies of the circularly permuted tobacco mosaic viral capsid protein (cpTMVs) are used as models of photosynthetic light harvesting complexes. These samples produced ions in the 0.6-4.7 MDa range making them well suited to evaluate the performance of data processing methods for single ion CDMS. A previously unreported mutant of cpTMV containing a non-canonical acid, 3-nitrotyrosine (3NY), at position S65 (cpTMV-S65-3NY) was used in this example due to its assembly homogeneity. See FIG. 12.

The acquired time-domain data was analyzed using a STFT, where transients are divided into segments of time and then apodized using either a rectangular (i.e. unapodized), Hann or Gaussian (σ=8 ms) function, zero-filled, and subsequently Fourier transformed.

A segment size of 50 ms (50,000 data points) was used, corresponding to 20 Hz bin sizes in frequency space. Zero-filling, where zeros were added to the end of each segment in multiples of the original segment length, was used to reduce the size of frequency domain bins. Herein, adding n equivalents of the window length in zeroes is described as adding n zero-fills. For example, if a 50 ms segment has two zero-fills, then the zero-filled segment will contain 50 ms of real data, and 100 ms of zeroes (50,000 real data points and 100,000 zeros).

Subsequent segments were stepped across the time domain in 5 ms intervals, i.e., 0-50 ms, 5-55 ms, etc., which enabled the tracing of ion signals in the frequency domain as ion frequency evolved in time. All data analysis was performed using the Python programming language, version 3.10, on a desktop computer equipped with a 12 core, 24 thread Ryzen 5900 processor (AMD, Santa Clara, CA, USA), 128 gigabytes of DDR4 RAM (G Skill, Taipei, Taiwan).

The Fourier transform of a rectangular window of arbitrary length yields a sinc function that is given as (Equation 1):

$$Sin c ( x ) = \frac{Sin ( π x )}{π x} .$$

The sinc function was fit to magnitude Fourier transform data by taking the absolute value, and for signals occurring at any amplitude, width, center frequency and baseline by adding the parameters A, w, fc, and B, respectively as shown in the following (Equation 2):

$$Sin c ( f , A , w , {f}_{c} , B ) = A \vert \frac{Sin ( π w ( f - {f}_{c} ) )}{π w ( f - {f}_{c} )} \vert + B .$$

This process can be repeated for Hann and Gaussian windows to yield an analytical description of their frequency domain peak shapes, but this derivation is not included nor used in this example.

Fitting of the real or imaginary components of the Fourier transformed data instead of using the magnitude representation of the two components will also yield accurate amplitude information, but both the real and imaginary components require a different function for fitting that is also not specified here.

Ion signals were fit to Equation 2 using non-linear least squares fitting utilizing the Levenberg-Marquardt algorithm and required initial conditions that are given by the peak height and center frequency from the Fourier transform, a width that is given by the window length in seconds, and a baseline that is initially set to zero. Peak fitting in this analysis was unconstrained, and the final fitted peak height is the sum of parameters A and B after optimization. In the experiments described here, this process of fitting rectangularly apodized frequency domain peaks is referred to as sinc fitting. The process of picking out the highest amplitude and corresponding frequency along a peak in the frequency domain without using the optimized fit equation is referred to as peak picking.

### Example 2

To further demonstrate the benefits of the data processing methods, the improvements in observed scalloping loss of the methods were evaluated. In FT-based methods, the resolution or ability to distinguish signals of ions that have similar frequencies depends on several factors, including the length of the time-domain signal. In CDMS, the frequencies of ions evolve with time as a result of small changes in ion trajectories as well as collisions with background gas that reduce ion energy. The latter effect on frequency can be minimized but not entirely eliminated with traps that have harmonic-like potentials. Because ion frequencies can evolve with time, a STFT analysis in which shorter time segments during which ion frequency does not change significantly are used to analyze the time-domain data.

A short time window is also advantageous for high time resolution, for example, identifying when an ion fragments or enters an unstable orbit within the trap. The ability to accurately determine the frequency and amplitude of individual ions also depends on the duration of the time-domain signal. The length of the time-domain signal can be increased by zero-filling, which does not affect peak width but does increase the accuracy with which a peak centroid and amplitude can be obtained by reducing the size of the corresponding frequency domain bins. This reduces what is referred to as scalloping loss, which is a systematic negative error in the measured peak height when it is determined solely by the highest point along the peak, i.e., when ‘peak-picking’ is used.

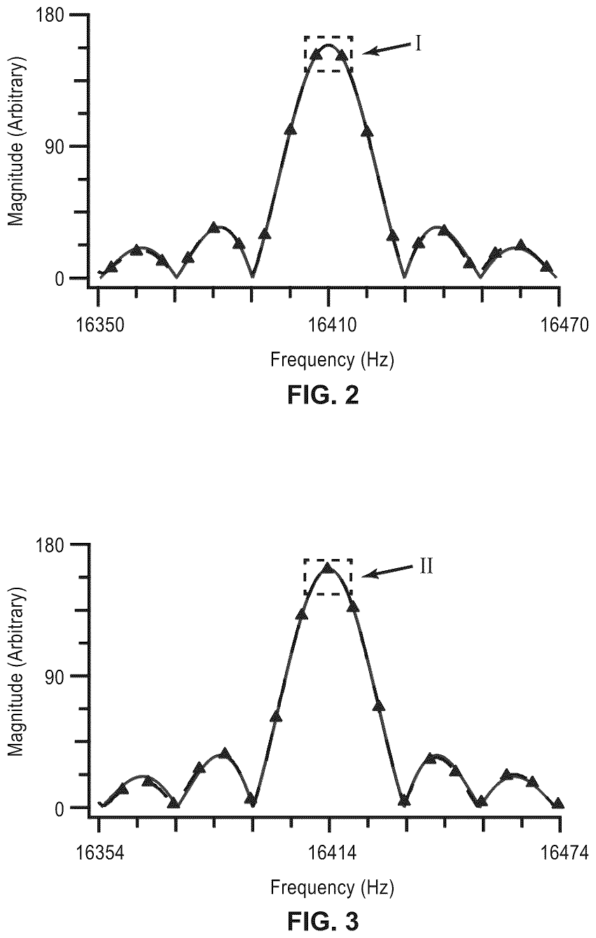

The effect of scalloping loss is illustrated in FIG. 2 and FIG. 3, which show the measured signal from a single AAV9 ion (4.7 MDa) at two different times over a 1 second trapping period. The signal was processed using 50 ms of data, rectangular apodization (unapodized), and with two zero-fills (100 ms), yielding 6.67 Hz bin widths in frequency space. The peak of the ion signal can fall in-between bins resulting in a maximum value that is offset from the true frequency by up to 3.4 Hz and an amplitude that is lower than the true value as shown in FIG. 2, or it can be centered directly on a bin which results in high accuracy centroid determination, and subsequently, high amplitude accuracy as shown in FIG. 3.

Inaccuracies in peak height measurement that stem from scalloping loss are traditionally mitigated through large numbers of added zero-fills to the measured time-domain data. This is illustrated by the dotted black lines in FIG. 2 and FIG. 3, which correspond to the same time-domain signals that are zero-filled to total time-domain length of 2000 ms. Although the “true” peak frequency and amplitude can be obtained with a sufficiently large number of zero-fills, the longer time-domain data leads to increased computation time and cost. This necessitates high-performance computing or lower-level (more efficient) software in order to enable real-time processing of the CDMS data.

Conversely, apodization specific fitting makes it possible to accurately determine peak centroid frequency and amplitude using fewer zero-fills through interpolation, which results in lower computation time. The results of a rectangular apodization fitting using the same 50 ms of data and 100 ms zero-fills (150 ms FT) are shown as peak lines in FIG. 2 and FIG. 3. These fits are nearly indistinguishable from the results obtained with the significantly larger number of zero-fills, but this fitting requires only a fraction of the computing time.

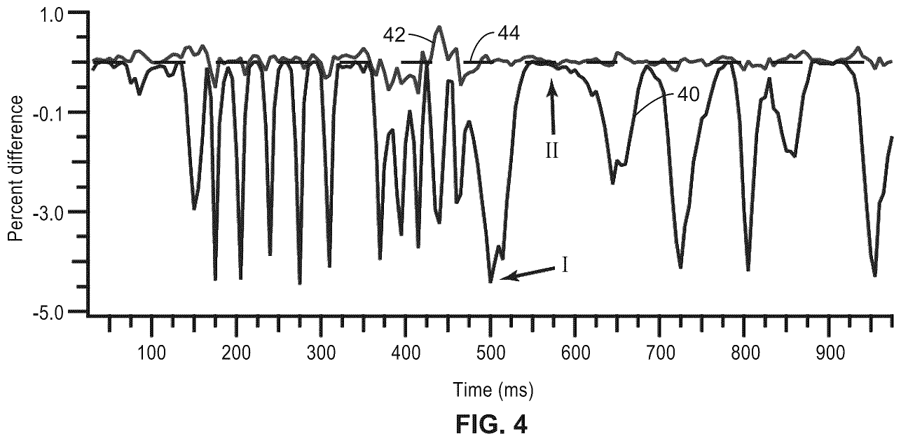

The error in amplitude due to scalloping loss changes in magnitude over the course of the measurement because the frequency of an ion can shift with time. The shifting ion frequency results in an error in amplitude that is a maximum when it bisects two frequency domain bins (FIG. 2) and a minimum when it occurs on top of a frequency domain bin (FIG. 3). This variable error is illustrated in FIG. 4, which shows the deviation of peak peaking (line 40) and sinc fitting (line 42) as compared to the results of the 2000 ms zero-filled data (dashed line 44) where scalloping loss is negligible for the 1 second duration of the trapping period. The error ranges from −4.46% and −0.00% and has an average value of −1.21%.

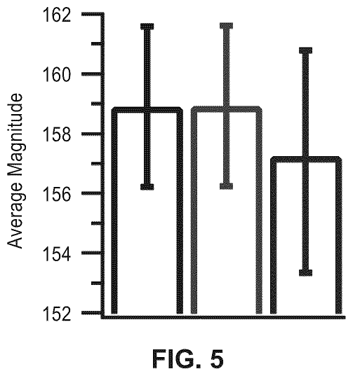

In contrast, the fitted amplitudes obtained with the same number of zero-fills varies between −0.64% and +0.72% and has an average deviation of just 0.02%. The average peak amplitude and standard deviation of a single AAV9 ion obtained using peak picking and 39 zero-fills (first), sinc fitting and two zero-fills (middle), and peak picking and two zero-fills (second) are shown in FIG. 5.

Other factors affect the variability of the absolute measured amplitude of ion signals, including random noise, collisions with background gas that reduce ion energy and can also result in a small shift in ion trajectories. The latter two phenomenon affect the duty cycle of the ion signal, which changes the amplitudes of the fundamental frequency and the corresponding harmonic frequencies. Thus, the standard deviation in the amplitude of the fundamental frequency does not reflect the standard deviation in charge measurement because the effects of signal duty cycle are taken into account in the determination of ion charge.

Moreover, the ratio of the abundances of the second harmonic to the fundamental frequency is used to obtain ion energy throughout the measurement, so an improvement in amplitude measurements corresponds to improvements in ion energy resolution. This is essential for a multiplexing scheme that enables multiple ions with the exact same m/z to be analyzed simultaneously if these ions have different kinetic energies.

To determine the extent to which sinc fitting improves the absolute amplitude measurements of the fundamental frequency used to determine charge, results from peak picking and apodization specific fitting of 150 ms time-domain data (50 ms experimental data and 100 ms of zero-fills) was compared to 2000 ms time-domain data with the same number of experimental data and the remainder zero-filled. The signal amplitudes of the resulting 190 STFT segments that were obtained using peak picking and from sinc fitting have standard deviations of 3.72 a.u. and 2.68 a.u., respectively. This equates to an ˜28% improvement in amplitude standard deviation and, by extension, an ˜28% reduction in charge uncertainty.

Amplitudes obtained from the 2000 ms time domain standard also have a standard deviation of 2.68 a.u., indicating that fitting approached the maximum amplitude precision that can be achieved through high levels of added zero-fills. Even in cases where the frequency of an individual ion does not change in time and thus scalloping losses are consistent over the trapping period, the amplitudes of the many individual ions required to compile a CDMS mass histogram will have different extents of scalloping losses at their respective frequencies, broadening the overall distribution of amplitudes and increasing charge uncertainty.

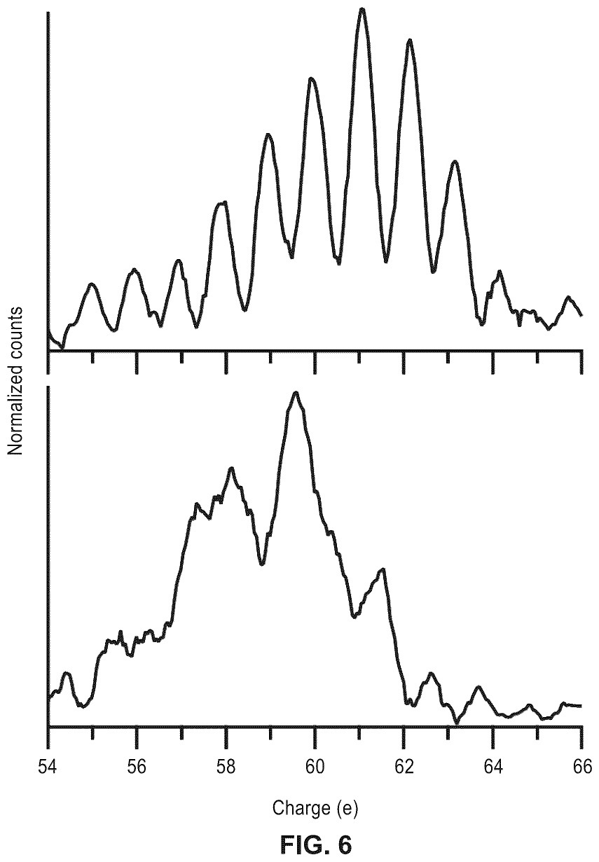

In order to determine the improvement in amplitude (charge) accuracy from sinc fitting, data for ˜400 cpTMV-S65-3NY ions (602 kDa) trapped for 7.5 seconds were compared to determine the effect on the accuracy of charge-state measurements. Charge histograms are shown in FIG. 6 showing normalized counts as a function of peak amplitude (charge) for approximately 400 cpTMV-S65-3NY ions using sinc fitting (top) and peak picking (bottom) showing improved charge state resolution with sinc fitting.

Without sinc fitting, individual charge states are not clearly resolved. In contrast, charge states between 59+ and 65+ were individually well-resolved with sinc fitting. Fitting these data to Gaussian peak shapes resulted in an average charge uncertainty of ˜0.254 e. The improved charge-state resolution with sinc fitting was a direct result of reduced scalloping loss and was the first example of amplitude only-based charge state resolution measured using CDMS without the use of a cryogenically cooled preamplifier.

It is also important to note that sinc fitting resulted in a higher median value of charge. This is due to the systematically lower amplitudes that are obtained from peak picking with few zero-fills. In cases where individual charge states are not resolved, the effects of scalloping loss need to be accounted for through calibration.

### Example 3

A comparison of apodization functions was conducted to demonstrate the superior function of the methods. Rectangular apodization yields peaks that are the narrowest in the frequency domain compared to other apodization functions. For experiments in which only one or no ions are trapped, higher frequency resolution is not an advantage. However, higher resolution is advantageous in multiplexing experiments where the individual masses of many ions are measured simultaneously as a result of lower probability that the signals of any two ions will overlap in frequency. Thus, more ion traces in congested regions of frequency space can be resolved leading to an even greater extent of multiplexing that is possible for faster acquisition of mass spectra.

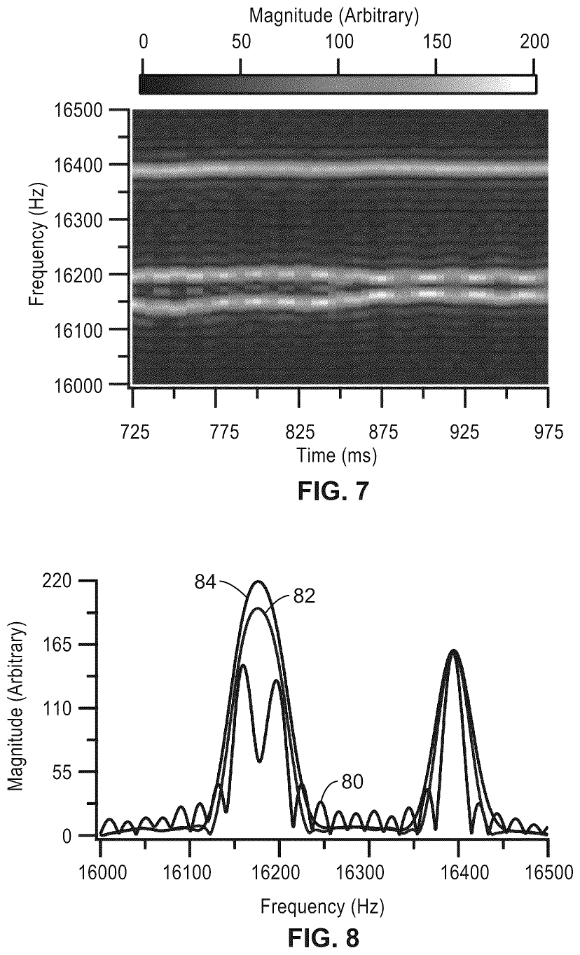

The advantage of the higher resolution obtained with rectangular apodization in multiplexed CDMS measurements is illustrated in FIG. 7, which shows a limited frequency range over which the frequencies of three AAV9 ions were measured for one second (data from 725 to 975 ms was acquired). The frequencies of two of these ions were similar with a minimum frequency separation of ˜40 Hz at 885 ms. A one-dimensional FT “slice” of the STFT of data in the 50 ms segment that is centered at 885 ms is shown in FIG. 8 using a rectangular apodization function, a Hann apodization function 82 and a Gaussian apodization function 84. The frequencies of the two ions are clearly resolved as two distinct peaks with a rectangular apodization. However, the frequencies are completely unresolved with both the Hann and Gaussian apodization. The higher resolution obtained with rectangular apodization can lead to a significant increase in the number of resolvable ions in multiplexed measurements. Because ions with similar mass, charge, and energy will have similar frequencies, time-domain data with the signal from many ions may result in the suppression of the most common ions due to the higher probability of frequency overlaps. Higher resolution obtained with rectangular apodization, however, will yield the minimum extent of suppression of more abundant ions because narrower peaks reduce the probability of signal overlap.

The higher resolution obtained with a rectangular apodization function comes at the cost of a greater extent of spectral leakage, i.e., “ringing.” This can be clearly seen in FIG. 8 as well as FIGS. 2 and 3 as oscillations on either side of the main peaks and as well as low intensity parallel traces to the main frequencies on FIG. 7. These side bands have the potential to obscure low intensity signals with frequencies on either side of a main peak.

Rectangular apodization has the lowest equivalent noise bandwidth of any apodization function, which translates to a lower noise baseline and higher signal-to-noise ratio (S/N) in Fourier transforms of sinusoidal signals.

To investigate whether this is also true of the unique periodic ion signals in CDMS, the same AAV9 ion signals from data shown in FIG. 2 was processed with a rectangular, Hann, and Gaussian apodization under otherwise identical parameters.

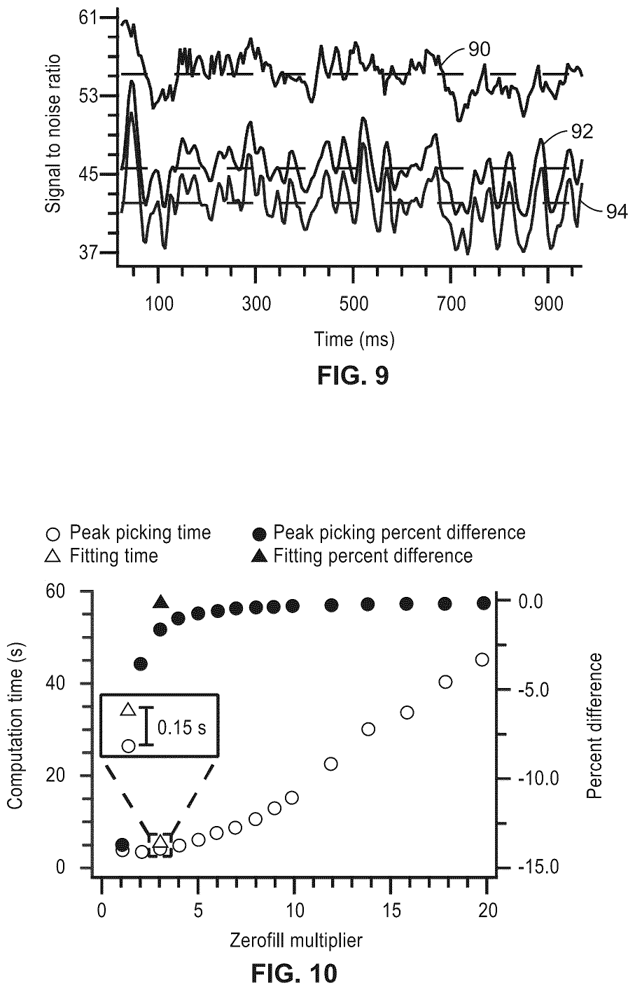

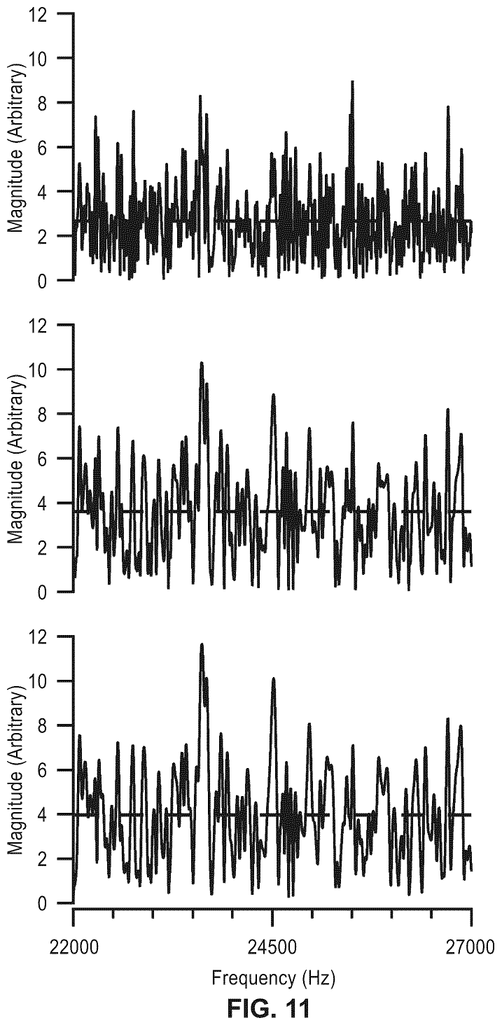

The S/N of a single AAV9 ion over each “slice” of the STFT for the 1 second trapping period for the three apodization functions: rectangular 90, Gaussian 92 and Hann 94 are shown in FIG. 9. The results and description of S/N analysis are also provided in FIG. 11. It can be seen that the S/N with the Hann apodization is slightly greater than that of the Gaussian apodization, but the rectangular apodization function results in a S/N ratio that is between about 1.21 and 1.26 times greater than the Hann and Gaussian functions, respectively. Thus, the S/N advantage of rectangular apodization also applies to the periodic but not sinusoidal signals of CDMS. This leads to a corresponding direct improvement in charge measurement accuracy.

Although the rectangular apodization function is not always preferred in applications such as FT-ICR and other FT-based analytical techniques due to its effect on the dynamic range of closely spaced signals, it is ideal for CDMS analysis because it makes it possible to analyze more ions per unit time due to its narrower intrinsic peak width in the frequency domain, and it decreases charge uncertainty due to its low equivalent noise bandwidth.

### Example 4

To demonstrate the superior computation time savings, the benefits of the peak fitting approach were evaluated. Sinc fitting requires significantly fewer zero-fills to obtain accurate frequency and amplitude (charge) measurements compared to those values obtained from peak picking. This results in a substantial reduction in computation time that enables uncompromised real time data processing of CDMS data with relatively limited computing power. In order to determine the number of zero-fills required to obtain similar accuracy to sinc fitting that uses two zero-fills, data for 20 individual 1 second trapping periods sampled at 1 MHz was processed with a varying number of zero-fills. A total of 56 AAV9 ions were identified and trapped for the duration of these 20 periods. The time required to process these data as a function of the number of added zero-fills and that for the fitting procedure are shown in FIG. 10. The total computation time shown in red (left y-axis) is for processing 20 seconds of acquired data with peak picking (circles) and peak fitting (triangle) and the percentage difference between the average peak amplitude compared to that with 39 added zero-fills (the equivalent of a 2000 ms time domain sample, creating 0.5 Hz frequency domain bin widths) is shown in blue (right y-axis). The computation time increases only marginally with up to five zero-fills as a result of the ability to parallelize processing these data over multiple processor cores. The error decreases rapidly over this range but is still −0.38% at five zero-fills. Between 5 to 9 zero-fills, the computation time required increases more rapidly, but real time data processing can still be accomplished with up to 9 zero-fills. With 9 zero-fills, the total computation time is 15.4 seconds and results in an amplitude percent deviation of −0.12%. The computation time increases more linearly with increasing number of zero-fills above 10 due to limitations in internal data transfer speeds in the random-access memory of the computer. The accuracy approaches the asymptotic value corresponding to the value with 39 added zero-fills (2000 ms of transformed data).

By comparison, the apodization function specific fitting with two zero-fills results in an average amplitude percent deviation of just +0.03% while requiring only 5 seconds to analyze 20 individual 1 second transients. Thus demonstrating that the method enables real time processing of CDMS data with high precision.

In contrast, processing with 9 zero-fills without fitting took three times longer and resulted in an amplitude error that is four times higher. In order to obtain a comparable level of accuracy to that obtained by using fitting and 3 zero-fills, 19 zero-fills are necessary using only peak picking and 45.6 seconds of computation time is required for analysis. Thus, the fitting procedure results in more than a 9-fold gain in data analysis speed while providing the same accuracy as that of zero-filling alone.

Fitting frequency domain peaks introduces an “overhead” cost to the overall computation time compared to the time necessary without fitting when the same number of zero-fills is used. With two zero-fills, the fitting procedure increased the computation time by approximately 0.15 seconds. This overhead depends on the number of ions found in each file. For these data, there were an average of 2.8 ions per file corresponding to an overhead of 2.7 ms per ion. The overhead time should increase roughly linearly with the number of ions in each file. Based on these data, it is expected that files containing signals for up to approximately 288 ions can still be computed in real time.

The computation time required for this analysis was found to be both computer and software dependent. Python is a higher-level language and has the advantage of being easy to use to develop complex software routines. However, it is not the most efficient for computing Fourier transforms. A lower-level language could substantially reduce these computation times. Initial results in the C++ programming language indicate that a nearly ten-fold reduction in computation time may be achieved, making significantly more zero-fills possible in real time or making real-time processing of data on a laptop computer possible using the sinc fitting method.

Accordingly, it can be seen that in single ion charge detection mass spectrometry measurements, where the m/z of an ion is obtained from the oscillation frequency and ion energy, and the charge of the ion is determined from the amplitude of the induced signal, accurate amplitude measurements are essential. Scalloping loss arising from peak picking of limited time-domain data segments in STFT analysis of CDMS data can occur unless a large number of zero-fills are used for each segment. However, this comes at a significant cost of computation time leading to the use of off-line data analysis on standard desktop computers or a highly efficient computing cluster for real time data analysis. Apodization specific fitting substantially reduces the number of zero-fills needed to reduce scalloping loss to a negligible value and results in a 9-fold reduction in computation time compared to zero-filling to a similar accuracy without fitting. In combination with a lower-level language for the computation of fast Fourier transforms, it should be possible to process these data in real time on a laptop computer.

Although Gaussian, Hann, and other apodization functions are often used in other FTMS methods, as well as in some CDMS measurements, it has been demonstrated that rectangular apodization significantly improves frequency resolution for the individual ion signals measured in CDMS. This improved frequency resolution is advantageous for ion multiplexing measurements where ions with similar frequencies can be more easily resolved. Equally important is the >20% S/N gain obtained with rectangular apodization compared to Gaussian and Hann apodization. This improvement in S/N translates into a corresponding improvement in charge measurement accuracy and in ion energy measurements that are obtained from signal amplitudes of the fundamental and harmonic frequencies.

Embodiments of the present technology may be described herein with reference to flowchart illustrations of methods and systems according to embodiments of the technology, and/or procedures, algorithms, steps, operations, formulae, or other computational depictions, which may also be implemented as computer program products. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure(s) algorithm(s), step(s), operation(s), formula (e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored locally to the device in non-transitory media or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, the terms processor, hardware processor, computer processor, central processing unit (CPU), and computer are used synonymously to denote a device capable of executing the instructions and communicating with input/output interfaces and/or peripheral devices, and that the terms processor, hardware processor, computer processor, CPU, and computer are intended to encompass single or multiple devices, single core and multicore devices, and variations thereof.

From the description herein, it will be appreciated that the present disclosure encompasses multiple implementations of the technology which include, but are not limited to, the following:

A method for individual ion charge detection mass spectrometry, the method comprising: (a) acquiring time domain Charge Detection Mass Spectrometry data containing individual ion signals; (b) applying an apodization function to the time domain data; (c) applying a Fourier transform to the apodized time domain data; (d) applying an apodization-specific peak fitting function to determine ion signal peak amplitudes and frequencies in the Fourier transform of the apodized time domain data; and (e) using the amplitudes and frequencies to determine one or more of individual ion mass-to-charge ratio (m/z) values, charge (z) values, and mass (m) values.

The method of any preceding or following implementation, wherein the Charge Detection Mass Spectrometry data comprises multiplexed CDMS measurements.

The method of any preceding or following implementation, wherein the Fourier transform comprises a Short Time Fourier-transform (STFT).

The method of any preceding or following implementation, wherein the apodization-specific peak fitting function is a function that is complementary to the apodization function applied to the time domain data.

The method of any preceding or following implementation, wherein the time domain data is apodized with a rectangular apodization function.

The method of any preceding or following implementation, wherein the apodization specific peak fitting function comprises a sinc fitting function, wherein ion signals are fit to the sinc fitting function using a non-linear least squares fitting algorithm.

The method of any preceding or following implementation, wherein the sinc fitting function comprises:

$$Sin c ( f , A , w , {f}_{c} , B ) = A \vert \frac{Sin ( π w ( f - {f}_{c} ) )}{π w ( f - {f}_{c} )} \vert + B .$$

The method of any preceding or following implementation, further comprising applying a Savitzky-Golay filter or other smoothing algorithm to the determined frequency, amplitude, mass or charge data.

A method for single ion charge detection mass spectrometry, the method comprising: (a) acquiring time domain Charge Detection Mass Spectrometry data containing individual ion signals; (b) applying an apodization function to the time domain data; (c) applying a short-time Fourier transform (STFT) to the apodized time domain data; (d) applying an apodization-specific peak fitting function to determine ion signal peak amplitudes and frequencies in the short-time Fourier transform (STFT) of the apodized time domain data; and (e) using the amplitudes and frequencies to determine one or more of individual ion mass-to-charge ratio (m/z) values, charge (z) values, and mass (m) values; (f) wherein up to approximately 28% or more amplitude measurement precision is achieved when compared to conventional peak picking methods.

A peak fitting method, comprising using an apodization-specific peak fitting function to determine peak amplitudes and frequencies in a Fourier transform of ion signals to measure the charge and mass of individual ions in charge detection mass spectrometry.

The method of any preceding or following implementation, wherein about a 9-fold less computational effort is required to achieve the same accuracy of determining peak amplitude and frequency as the standard method of zero fill-based interpolation.

The method of any preceding or following implementation, wherein rectangular apodization is employed in conjunction with a peak fitting function.

The method of any preceding or following implementation, wherein a function that is complementary to the apodization function applied to the time domain data is employed to fit the frequency domain data.

The method of any preceding or following implementation, wherein non-linear least squares algorithm is applied to an apodization-specific peak fitting function to fit peaks in the Fourier transformed ion signal.

The method of any preceding or following implementation, wherein a known peak shape is used for fitting frequency domain data.

A method for single ion charge detection mass spectrometry, the method comprising: (a) acquiring time domain Charge Detection Mass Spectrometry data containing individual ion signals; (b) applying an apodization function to the time domain data; (c) applying a mathematical transform to the apodized time domain data that yields the frequency components of the time domain signal; (d) using the amplitudes and frequencies to determine individual ion mass-to-charge ratio (m/z) values, charge (z) values, and mass (m) values.

The method of any preceding or following implementation, wherein a peak fitting function is used to determine ion signal peak amplitudes and frequencies in the mathematical transform of the apodized time domain data.

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C,” within the present disclosure describe where either A, B, or C can be present, or any combination of items A, B and C. Phrasing constructs indicating, such as “at least one of” followed by listing a group of elements, indicates that at least one of these groups of elements is present, which includes any possible combination of the listed elements as applicable.

References in this disclosure referring to “an embodiment,” “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system, or method.

As used herein, the term “set” refers to a collection of one or more objects. Thus, for example, a set of objects can include a single object or multiple objects.

Relational terms such as first and second, top and bottom, upper and lower, left and right, and the like, may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, apparatus, or system, that comprises, has, includes, or contains a list of elements does not include only those elements but may include other elements not expressly listed or inherent to such process, method, article, apparatus, or system. An element proceeded by “comprises . . . a”, “has a”, “includes . . . a”, “contains . . . a” does not, without more constraints, preclude the existence of additional identical elements in the process, method, article, apparatus, or system, that comprises, has, includes, contains the element.

As used herein, the terms “approximately”, “approximate”, “substantially”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way but may also be configured in ways that are not listed.

Benefits, advantages, solutions to problems, and any element(s) that may cause any benefit, advantage, or solution to occur or become more pronounced are not to be construed as a critical, required, or essential feature or element of the technology described herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after the application is filed. Accordingly, the reader should consult the application as filed for the original content of the disclosure. Any deletion of content of the disclosure should not be construed as a disclaimer, forfeiture, or dedication to the public of any subject matter of the application as originally filed.

The following claims are hereby incorporated into the disclosure, with each claim standing on its own as a separately claimed subject matter.

Although the description herein contains many details, these should not be construed as limiting the scope of the disclosure, but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A method for individual ion charge detection mass spectrometry, the method comprising:
(a) acquiring time domain Charge Detection Mass Spectrometry data containing individual ion signals;
(b) applying an apodization function to said time domain data;
(c) applying a Fourier transform to said apodized time domain data;
(d) applying an apodization-specific peak fitting function to determine ion signal peak amplitudes and frequencies in the Fourier transform of the said apodized time domain data; and
(e) using said amplitudes and frequencies to determine one or more of individual ion mass-to-charge ratio (m/z) values, charge (z) values, and mass (m) values.

2. The method of claim 1, wherein said Charge Detection Mass Spectrometry data comprises multiplexed CDMS measurements.

3. The method of claim 1, wherein said Fourier transform comprises a Short Time Fourier-transform (STFT).

4. The method of claim 1, wherein said apodization-specific peak fitting function is a function that is complementary to the apodization function applied to the time domain data.

5. The method of claim 1, wherein said time domain data is apodized with a rectangular apodization function.

6. The method of claim 5, wherein said apodization specific peak fitting function comprises:
a sinc fitting function;
wherein ion signals are fit to the sinc fitting function using a non-linear least squares fitting algorithm.

7. The method of claim 6, wherein said sinc fitting function comprises:
$$Sin c ( f , A , w , {f}_{c} , B ) = A \vert \frac{Sin ( π w ( f - {f}_{c} ) )}{π w ( f - {f}_{c} )} \vert + B .$$

8. The method of claim 1, further comprising:
applying a Savitzky-Golay filter or other smoothing algorithm to said determined frequency, amplitude, mass or charge data.

9. A method for single ion charge detection mass spectrometry, the method comprising:
(a) acquiring time domain Charge Detection Mass Spectrometry data containing individual ion signals;
(b) applying an apodization function to said time domain data;
(c) applying a short-time Fourier transform (STFT) to said apodized time domain data;
(d) applying an apodization-specific peak fitting function to determine ion signal peak amplitudes and frequencies in the short-time Fourier transform (STFT) of the apodized time domain data; and
(e) using said amplitudes and frequencies to determine one or more of individual ion mass-to-charge ratio (m/z) values, charge (z) values, and mass (m) values;
(f) wherein up to approximately 28% or more amplitude measurement precision is achieved when compared to conventional peak picking methods.

10. The method of claim 9, wherein said Charge Detection Mass Spectrometry data comprises multiplexed CDMS measurements.

11. The method of claim 9, wherein said apodization-specific peak fitting function is a function that is complementary to the apodization function applied to the time domain data.

12. The method of claim 9, wherein said time domain data is apodized with a rectangular function.

13. The method of claim 12, wherein said apodization specific peak fitting function comprises:
a sinc fitting function;
wherein ion signals are fit to the sinc fitting function using a non-linear least squares fitting algorithm.

14. The method of claim 13, wherein said sinc fitting function comprises:
$$Sin c ( f , A , w , {f}_{c} , B ) = A \vert \frac{Sin ( π w ( f - {f}_{c} ) )}{π w ( f - {f}_{c} )} \vert + B .$$

15. The method of claim 9, further comprising:
applying a Savitzky-Golay filter or other smoothing algorithm to said determined frequency, amplitude, mass or charge data.

16. A peak fitting method, comprising using an apodization-specific peak fitting function to determine peak amplitudes and frequencies in a Fourier transform of ion signals to measure the charge and mass of individual ions in charge detection mass spectrometry.

17. The method of claim 16, wherein about a 9-fold less computational effort is required to achieve the same accuracy of determining peak amplitude and frequency as the standard method of zero fill-based interpolation.

18. The method of claim 16, wherein rectangular apodization is employed in conjunction with a peak fitting function.

19. The method of claim 16, wherein a function that is complementary to the apodization function applied to the time domain data is employed to fit the frequency domain data.

20. The method of claim 16, wherein a non-linear least squares algorithm is applied to an apodization-specific peak fitting function to fit peaks in the Fourier transformed ion signal.

21. The method of claim 16, wherein a known peak shape is used for fitting frequency domain data.

22. A method for single ion charge detection mass spectrometry, the method comprising:
(a) acquiring time domain Charge Detection Mass Spectrometry data containing individual ion signals;
(b) applying an apodization function to said time domain data;
(c) applying a mathematical transform to said apodized time domain data that yields the frequency components of the time domain signal;
(d) using amplitudes and frequencies in the mathematical transform to determine individual ion mass-to-charge ratio (m/z) values, charge (z) values, and mass (m) values.

23. The method of claim 22, wherein said Charge Detection Mass Spectrometry data comprises multiplexed CDMS measurements.

24. The method of claim 22, wherein a peak fitting function is used to determine ion signal peak amplitudes and frequencies in the mathematical transform of the apodized time domain data.

25. The method of claim 22, further comprising:
applying a Savitzky-Golay filter or other smoothing algorithm to said determined frequency, amplitude, mass or charge data.
